(19) United States
(12) Patent Application Publication
(10) Pub. No.: US 2015/0150754 A1
(43) Pub. Date: Jun. 4, 2015

(54) DEVICE FOR MASSAGING AND THE APPLICATION OF A COSMETIC COMPOSITION

(71) Applicant: L'OREAL, Paris (FR)

(72) Inventors: Soraya Kadra, Asnieres Sur Seine (FR); Laure Thiebaut, Clichy (FR)

(21) Appl. No.: 14/413,688

(22) PCT Filed: Jul. 5, 2013
(86) PCT No.: PCT/EP2013/064279

§ 371 Date: Jan. 8, 2015

Related U.S. Application Data
(60) Provisional application No. 61/681,775, filed on Aug. 10, 2012.

(30) Foreign Application Priority Data
Jul. 9, 2012 (FR) 1256596

(51) Int. Cl. A61H 23/02

(52) U.S. Cl. CPC A61H 23/0254

(57) ABSTRACT

The present invention relates to a cosmetic device (1) comprising: —an end piece (5) comprising at least: —a first base (21) with a transverse axis (X) comprising at least one upstanding element (41), —a second base (22) with a transverse axis (X′) comprising at least one upstanding element (42), —a body (3) configured to receive the end-piece (5), —a first means for setting the first base (21) in vibratory motion relative to the body (3) along the axis (X), characterized in that it comprises a second means for setting the second base (22) in motion relative to the body (3).

The subject of the present invention is a device for massaging and/or cleansing and/or applying a cosmetic composition to a surface of the body.

According to the invention, “cosmetic device” is understood to mean a device for massaging and/or for cleansing and/or for applying a cosmetic composition.

In particular, this end-piece is particularly advantageous in the field of massaging certain zones of the body and of cleansing the skin, and in particular in deep cleansing for removing impurities from the pores of the skin. It may also be useful in applications for cleansing or for care of the body.

The expression “cosmetic product” is understood to mean a product as defined in Council Directive 93/35/EEC of 14 Jun. 1993.

The application of a cosmetic composition with the aid of a rotary device is known for example from FR 2 918 545 or U.S. Pat. No. 7,469,703.

The document US 2005/0278876 describes a device comprising a brush end-piece. This brush is divided into two coaxial concentric parts. One part is in the form of a disk, the other in the form of a ring. One part is fixed, the other is made to oscillate. The device is used for caring for the face, specifically for treating acne or imperfections or else for peeling or for shaving. It may also be used for caring for the feet or the scalp.

The document EP 744 139 discloses a domestic or household device, for example a toothbrush, a massaging device or a nailcare accessory. This device comprises an end-piece formed from at least two coaxial parts. The two parts can carry out an independent rotational movement with respect to one another. For example, one part rotates in the clockwise direction or in an oscillating manner. The other part rotates in the counterclockwise direction. This other part can also rotate in the clockwise direction or carry out an oscillating movement.

The document U.S. Pat. No. 7,320,691 describes a device that is also useful for the treatment of acne. This device comprises an end-piece formed from two coaxial parts. One part is fixed, the other is made to carry out a vibratory or oscillating movement on the surface treated.

It would be desirable to have cosmetic devices in the case of which the consumer feels the difference between the movements of the distinct parts to a greater extent. Specifically, in current devices, the difference in movement is sometimes difficult to perceive. For example, the user distinguishes little between a rotation in one direction and a rotation in the other direction.

There is a desire for a single device which could produce at least two distinct perceptible effects, the combination of which is more beneficial for the user than with prior art devices.

Within the scope of massaging the body or face, end-pieces that provide an improved sensation of well-being while improving blood circulation or lymphatic circulation, so as to produce a decongestant effect, for example in the region of the contour of the eyes, are desired.

Within the scope of cleansing or care of the face, massaging end-pieces which are soft but nevertheless effective for obtaining clean skin, without imperfections, having a uniform complexion and without redness, are desired. To this end, the objective of cleansing the face, in particular for greasy skin or skin prone to acne, is to avoid the proliferation of bacteria, such as P. acnes, in the pores of the skin. For what is known as normal to dry skin, the main objective of cleansing the face is to remove dead skin.

There also exists a need to provide low cost massaging end pieces, in order that they can be attached to any device for packaging a cosmetic composition, in particular when these devices contain active agents for cleansing the face.

There also exists a need for a massaging end-piece, the operation of which enables different levels of cleansing of the skin.

There also exists a need for a massaging end-piece suited to the hollows and reliefs of a face, in order to enable the cheekbones to be cleansed as well as the sides of the nose.

There are also exists a need for a massaging end-piece which provides new types of sensoriality while correctly applying the cosmetic products or while deep cleansing, and which massages in order to boost blood circulation and lymphatic circulation.

The object of the invention is to solve all or some of the problems identified above by proposing a cosmetic applicator comprising two bases in motion, each comprising upstanding elements. The movements are distinct and each independently perceptible by the user. The invention benefits from these separate movements in order to improve the effectiveness of the cosmetic device with respect to prior art devices.

The increase in effectiveness is connected with the clear difference between the movements of the two bases, each base carrying out a movement independent of the movement of the other base.

The subject of the invention is a cosmetic device (1) comprising:
an end-piece (5) comprising at least:
a first base (21) with a transverse axis (X) comprising at least one upstanding element (41),
a second base (22) with a transverse axis (X′) comprising at least one upstanding element (42),
a body (3) configured to receive the end-piece (5),
a first means for setting the first base (21) in vibratory motion relative to the body (3) along the axis (X),
   the device comprising a second means for setting the second base (22) in motion relative to the body (3),
   the first base (21) and the second base (22) being concentric.

Advantageously, the transverse axis (X) of the first base (21) is identical to the transverse axis (X′) of the second base (22).

The invention also relates to a cosmetic method comprising the use of the above device.

According to the invention, the upstanding elements are each terminated by a free end. This end comes into contact with the surface to be treated during the use of the device, in particular into contact with the skin.

According to the invention, the movement of the second base is different from the movement of the first base. The nature of the movements may be the same, but in this case the movements differ from one another in at least one of their parameters, such as their frequency or their speed of rotation. For example, the two bases may be made to vibrate, but the frequency of vibration is different for the first and the second base. The two bases may be made to rotate, but the speed of rotation is different for the first and the second base.

Advantageously, the movements of the first and second bases differ in terms of their natures and their parameters.

According to the invention, “mid-plane” is understood to mean a plane perpendicular to the base passing through the axis (X) of rotation of the brush.

A “cross section” is understood to mean a section through the base parallel to its transverse axis.

A “longitudinal section” is understood to mean a section through the base perpendicular to its transverse axis.

An “angular space” is understood to mean the angle between two mid-planes which are offset by an angle a about the axis (X).

The invention also relates to a kit comprising the above device.

The device according to the invention makes it possible to obtain a very satisfactory cleansing and massaging quality.

Base

The shape of the base is not limited. For example, in longitudinal and/or cross section, the base may have a square, rectangular, circular, triangular or parallelepipedal shape. The base may be solid or hollowed out, in particular at the center.

In a first embodiment, each base may have the shape of a substantially planar plate perpendicular to the axis X.

As a variant, or in addition, the plate may also have a concave shape.

The bases may consist of identical or different materials. A transparent material may in particular be envisaged, in order that the user can view the effect of the massage on his skin.

In one embodiment, the base has a certain flexibility so as to be elastically deformable during use. During application to the skin, this flexibility makes it possible to improve the quality of contact between the upstanding elements and the skin.

The base may have a circular perimeter in order to limit the risks of injury. In particular, it may have the form of a flat and circular plate.

The bases may be disposed alongside one another in a coaxial or non-coaxial manner.

According to a first embodiment of the device according to the invention, when the device is at rest, the surfaces where the upstanding elements are implanted on each base form surfaces of which the planes are distinctly or indistinguishably parallel.

According to a second embodiment of the device according to the invention, when the device is at rest, the surfaces where the upstanding elements are implanted on each base form surfaces of which the planes are intersecting.

The bases may be produced from a thermoplastic material, for example on the basis of acrylic compounds, cellulose-based compounds, polycarbonate compounds, polyamide compounds, styrene-based compounds, polyolefin compounds, vinyl-based compounds, polyethylene terephthalate compounds and/or of mixtures thereof in a variable proportion, which are expanded or not expanded. The base may also be produced from a thermoplastic resin, or from metal, or on the basis of a multilayer material, or of fibers, for example synthetic fibers. The plate may be sintered.

Movement of the Base

Advantageously, the second means for setting the second base in motion is a means for setting the second base in continuous or alternating motion along the axis (X).

More advantageously, the second means for setting the second base in motion is a means for setting in rotation, in oscillation or in percussion.

(i) Rotation

When the base is rotated by the driving means, the speed of rotation of the base may be for example between 100 and 400 rpm, preferably between 200 and 300.

The base may be rotated about a geometric rotation axis which is fixed relative to the body. As a variant, the base may be rotated about a geometric rotation axis which is able to move relative to the body. If necessary, the movement of the base may be an eccentric movement, and this can make it possible to spread the composition more regularly and with a more pronounced border between the treated region and the untreated region, this possibly being advantageous for a self-tanner for example.

The base may be rotated about a geometric rotation axis which forms a zero angle or non-zero angle with the longitudinal axis of the receptacle. A non-zero angle may improve ergonomics.

The base may be mounted removably on the massaging and application device, and this can make it possible to separate the application device in order to clean it and/or to replace it with another base selected depending on the treatment to be carried out or else to throw it away after use.

Advantageously, the direction of rotation of the base may be reversed by the user.

(ii) Oscillation

The means for setting in motion (or driving) may comprise a rocker having a transmission surface against which the massaging elements bear. The transmission surface may be planar. In this case, the ends of the upstanding elements which are in contact with the transmission surface preferably each have an opposing planar surface.

The transmission surface may be driven in oscillation about a pivot axis. This pivot axis may be located away from an edge of the massaging surface. For example, when the massaging surface is circular, the pivot axis may be chosen to pass through the center of the massaging surface.

In particular, the pivot axis may be parallel to a straight line defined perpendicularly to the longitudinal axes of in each case two upstanding elements. In this case, the upstanding elements which are in contact with the transmission surface at the pivot axis are the elements of which the movement relative to the base is less compared with those which are in contact with this same transmission surface but are located away from the pivot axis.

The pivot axis may be at right angles to a straight line defined perpendicularly to the longitudinal axes of in each case two other upstanding elements of the device. In this case, these two other upstanding elements, which are in contact with the transmission surface away from the pivot axis, are moved more than the two upstanding elements previously described, relative to the base.

The pivot axis may be at right angles to a longitudinal axis of a gripping member of the device. This makes it possible to simplify and reduce the number of parts necessary to form the driving means. Alternatively, if the pivot axis is not at right angles to a longitudinal axis of the gripping member of the device in which the motor is housed, then the device comprises a transfer system with pinions or an elastic coupling.

For example, the rocker may comprise two diametrically opposing protuberances in abutment against an internal lip of an external shell of the motorized device. Thus, the rocker is retained inside the external shell. These two protuberances preferably have a profile in the form of a circular arc intended to be in tangential abutment against said internal lip. The tangential abutment of these two protuberances is located in the plane defined perpendicularly to the transmission surface and passing through the pivot axis.

According to one embodiment of the invention, the driving means comprises a motor, a transmission shaft rotated about an axis by the motor, the rocker configured to oscillate about a pivot axis and comprising a cavity in which an eccentric end of the transmission shaft engages, the rotation axis of the transmission shaft intersecting the pivot axis such that the driving of the transmission shaft causes the rocker to oscillate between two angular positions so that the upstanding elements are moved through their openings depending on their angular location relative to the pivot axis.

(iii) Vibration

The means for setting in vibration may comprise a motor for producing vibrations, in particular a motor driving a flyweight or an eccentric, a piezoelectric or electromechanical vibrator. The speed of rotation of the motor may be for example between 4500 and 8000 rpm. The supply voltage used may be from 1.5 V to 3 V for example.

The means for setting in vibration may comprise an electrical power source. The use of a button cell may prove to be advantageous to reduce the space requirement of the device.

The assembly may comprise a regulating member allowing the user to regulate the frequency and/or amplitude of vibrations, and/or to regulate the orientation of the vibrations.

The vibration frequency may be, for example, greater than or equal to 20 Hz. The frequency may vary depending on the location or the pressure with which the vibrations are transmitted. The vibrations may be intermittent or continuous.

The vibrations may be oriented transversely to the longitudinal axis of the base or parallel thereto, or oriented in some other way.

The vibration amplitude of the applicator during application may be, for example, less than or equal to 5 mm, better still less than or equal to 3 mm, microvibrations of the applicator being preferable to vibrations of larger amplitude.

(iv) Percussion

A “percussive movement” is understood to mean a periodic impacting (or striking) movement of one surface against another. The percussive movement produces an effect of beating, tapping or repeated impacts on the surface of the body.

Generally, the percussion means comprises a means for converting the rotational movement of a drive shaft into a percussive movement. This function may be fulfilled by a gear train which allows the compression of an air cushion between two pistons. The percussion of the piston can be passed onto the percussion tool by way of an anvil. This percussion principle, which is known as an “electro pneumatic” percussion principle, allows a practically smooth movement.

The usual characteristics of the electric motor are:
Maximum no-load rotation speed: Nm=200 rpm, preferably 100 rpm, more preferably 50 rpm.
Maximum nominal power of the electric motor: P=50 W, preferably 30 W, more preferably 10 W.

In the device according to the invention, the percussive movement frequency is advantageously between 5 Hz and 100 Hz, preferably between 10 Hz and 50 Hz, more preferably between 20 Hz and 40 Hz.

Material Forming the Upstanding Elements

The upstanding element may comprise a cellular material which may be elastically deformable and/or compressible. This material may be a foam. The foam may be produced from a material selected from the following list: polyurethane, polyether, polyester, polyvinyl chloride, polyethylene, EVA, latex, silicone, SIS, SEBS, silicone elastomer, latex elastomer, nitrile elastomer, butyl elastomer, Neoprene®, NBR, SBR, this list not being limiting.

The upstanding element may have a composite structure having a plurality of layers having different natures, for example a number of types of foam.

The upstanding element may have any shape. It may have a circular, oval or polygonal cross section, for example a triangular, square, hexagonal, etc. cross section.

The upstanding element may have abrasive properties. “Abrasive property” should be understood as meaning a surface which, when moved over the skin, removes at least some of the dead cells from the surface.

Such surfaces can be characterized by an abrasive power of between 0.01 and 0.03 g/cm²/. The abrasive power corresponds to the quantity of plaster removed per minute, per square centimeter of an abrasive surface applied to a square of plaster having a thickness of 50 mm using a 135W Black and Decker CD 400 sander, the pressure exerted on the square of plaster resulting from the weight of the sander, only the movement of which in the plane of the abrasive surface is constrained.

Such upstanding elements are obtained either by taking a substantially rigid cellular material, or by incorporating hard grains into a flexible cellular material.

An example of an abrasive surface is a nonwoven exfoliating pad sold by 3M.

The foam may be a soft and flexible foam particularly suitable for spreading the product, sometimes also known as a sponge.

The upstanding element may be for example a hydrophilic crosslinked polyester foam, for example having a density equal to 32 kg/m³.

A sponge traditionally used for applying foundation, such as NBR, for example Yukilon® from Penthouse Group is also conceivable.

The upstanding element may be a thermocompressed foam. Thermocompression makes it possible to create reliefs on the surface of the foam and/or to complex it with an elastic fabric, thereby making it possible to have the flexibility of the foam but the feel of a textile more pleasant than that of plastic.

An example of a thermocompressed foam is a closed-cell foam made of polyolefin, for example thermocompressed polyethylene having a specific weight of 33 kg/m³, which is for example complexed with an elastic fabric such as for example Lycra®.

The upstanding element may be a file made of plastics material, metal or glass.

The upstanding element may be made of injection-molded flexible plastics material, for example of elastomer, and have massaging reliefs, for example spikes having pointed ends, rounded ends, a round, square, or triangular cross section, a length of between 1 mm and 40 mm for example, or balls having a round or oval cross section and a height of between 1 mm and 20 mm for example.

The upstanding element is for example made of an elastomer such as SEBS or silicone.

The upstanding element may be a brush made of synthetic or natural bristles, for example a bristled brush having tufts of strands of polyamide or PBT for example having a diameter of between 0.05 and 0.2 mm and more particularly made of Nylon® 6.12 having a diameter of 0.075 mm, which have been milled and ground in order to make them very soft in contact with the skin.

Implantation of the Upstanding Elements

The “end of the upstanding element” is understood to mean the point of the upstanding element which is farthest from the base and located on their main extension axis starting from their zone of attachment to the base in the direction of their free end.

The “height of the upstanding element” is understood to mean the distance measured along their main extension axis in the direction of their free end. Preferably, the height of the upstanding elements is between 0.1 and 3 cm.

The “thickness of the upstanding element” is understood to mean the maximum cross section of the upstanding element measured at their zone of attachment to the base. Preferably, the thickness of the upstanding elements is between 0.1 mm and 0.5 cm.

Advantageously, the device comprises upstanding elements such that the difference in height between two elements of extreme size is greater than 0.2 cm, preferably greater than 1 cm, and more preferably greater than 1.5 cm. This difference makes possible the efficacious alternation on the skin of the highest elements and the relaxation of the shortest elements.

The invention also relates to an assembly comprising a cosmetic receptacle comprising a through-hole in which at least one base designed to be used in a device as defined above is removably housed. In particular, this receptacle may be a tube or a bottle.

“The two elements of extreme size” are understood to be the element on the base having a maximum height and the element on the base having a minimum height.

The invention may be better understood on reading the following description of non-limiting implementation examples thereof, and with reference to the attached drawing, in which:

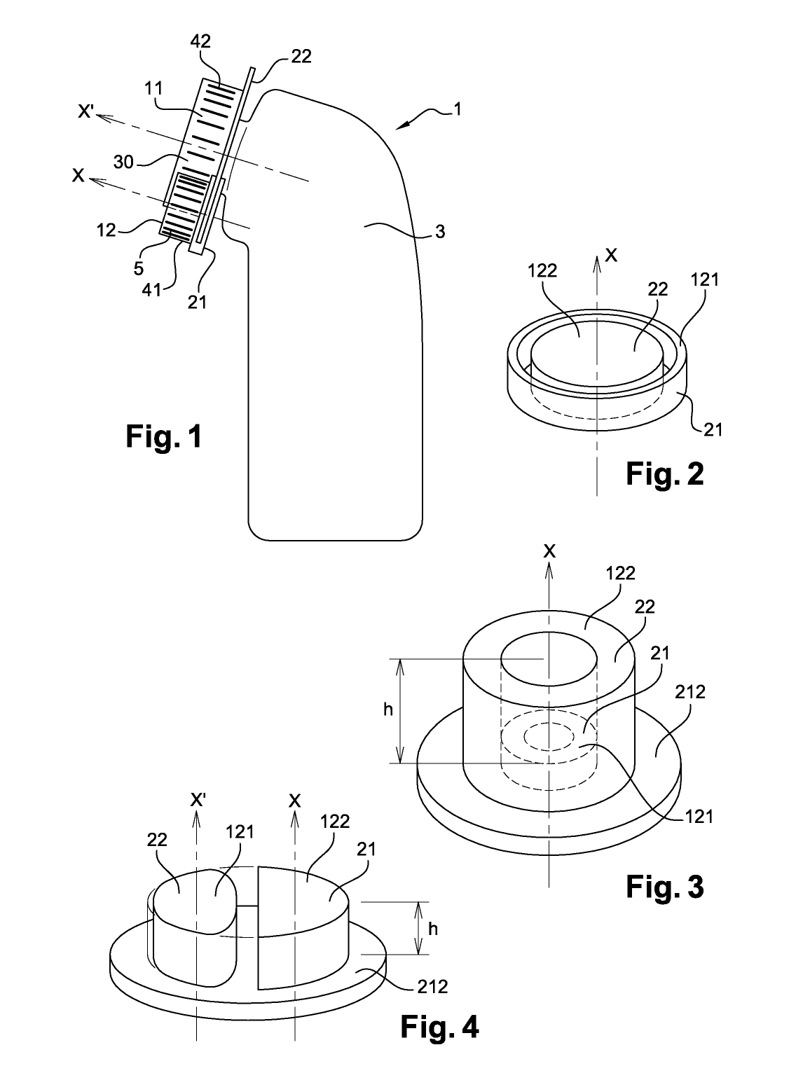

FIG. 1 schematically shows an example of a device according to the invention, in longitudinal section.

FIG. 2 is a schematic perspective view of a first end-piece according to the invention,

FIG. 3 is a schematic perspective view of a second end-piece according to the invention,

FIG. 4 is a schematic perspective view of a third end-piece according to the invention,

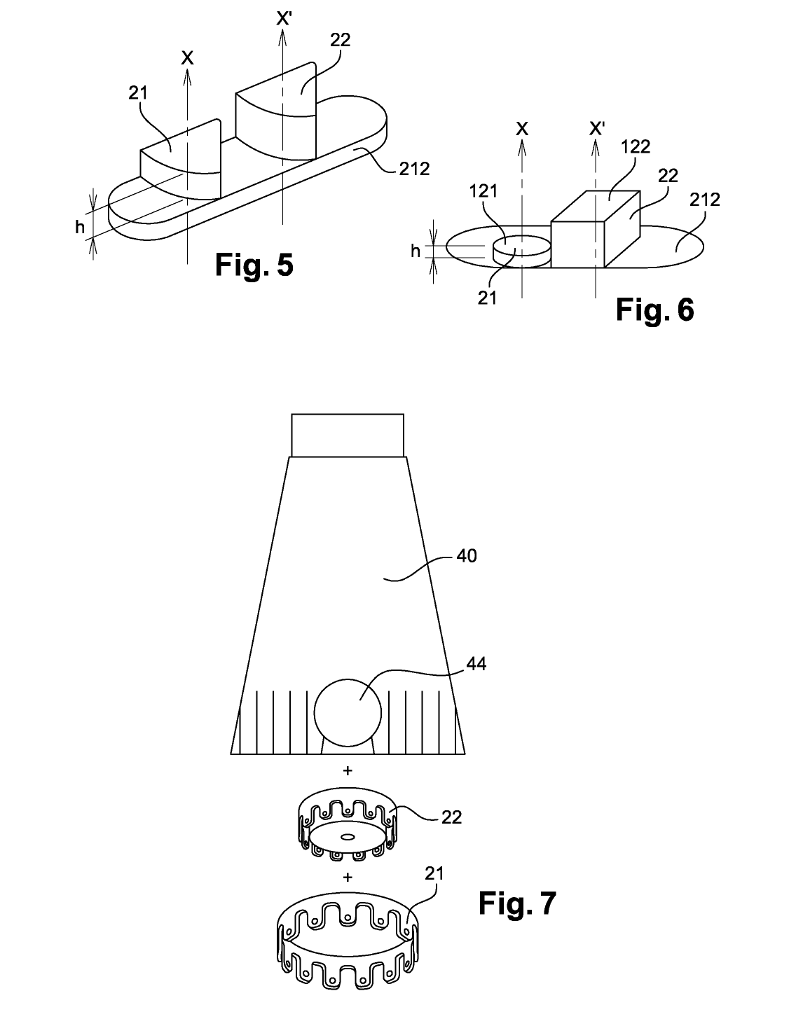

FIG. 5 is a schematic perspective view of a fourth end-piece according to the invention,

FIG. 6 is a schematic perspective view of a fifth end-piece according to the invention,

FIG. 7 schematically shows an example of an assembly according to the invention, in longitudinal section.

FIG. 1 shows a device 1 produced in accordance with the invention.

This device 1 comprises a body 3 on which there may be an end-piece 5 defining an application surface intended to come into contact with the skin. The end-piece comprises two bases 21 and 22 on which the upstanding elements 41 and 42 that end with the free ends 11 and 12 are implanted.

The body 3 may house means for driving the base 22 in a percussive movement along the axis X relative to the body 3.

The body 3 may house means for driving the base 22 in a rotational movement about the axis X′ relative to the body 3.

The means for rotating may comprise an electric motor which is housed in the body 3, is supplied by one or more batteries, and rotates the base 22 about the axis X by way of gears. The motor may also be driven by a battery or rechargeable battery.

The means for driving in percussion may comprise an additional electric motor which is housed in the body 3, is supplied by one or more batteries, and drives the base 21 in percussion along the axis X by way of gears. The motor may also be driven by a battery or rechargeable battery.

In the example of FIGS. 2 to 6, partially different end-pieces in accordance with the invention are shown, without showing the upstanding elements.

In FIG. 2, the bases 21 and 22 are coaxial with the axis X. The base 21 is a hollow cylinder. The base 22 is a solid cylinder housed in the base 21. The base 21 is vibrated along the axis X. The base 22 may be made to carry out a rotational, percussive or oscillating movement along the axis X. When the device is at rest, the surfaces 121 and 122 on which the upstanding elements are implanted are parallel and coincident and coplanar.

In FIG. 3, the bases 21 and 22 are coaxial with the axis X. The base 22 is a hollow cylinder having a height h. The base 21 is a solid cylinder housed in the base 22. The two bases are placed on a common plate 212 in the form of a disk. The base 21 is driven in percussion along the axis X. The means for driving this base 21 cause this base 21 to move by a height 2 h. It carries out a reciprocating movement along the axis X, limited by the common base 212. When it is made to carry out a percussive movement, the cylinder 21 periodically protrudes beyond the surface 121 of implantation of the upstanding elements of the base 22. It can beat against the surface of the body. When the device is at rest, the surfaces 121 and 122 on which the upstanding elements are implanted are parallel and distinct. The support 22 is made to vibrate.

In FIG. 4, the bases 21 and 22 each have a distinct longitudinal X and X′. The base 21 is a half disk. The base 22 is a disk. The two bases are placed on a common plate 212 in the form of a disk. The base 21 is driven in percussion along the axis X. When the device is at rest, the surfaces 121 and 122 on which the upstanding elements are implanted are parallel and coincident. The support 22 is made to vibrate.

In FIG. 5, the bases 21 and 22 each have a distinct longitudinal X and X′. The base 21 is a quarter disk. The base 22 is also a quarter disk. Its height measured along the axis X is twice the height of the base 21. The two bases are placed on a common plate 212 in the form of a disk. The base 21 is set in rotation about the axis X. When the device is at rest, the surfaces 121 and 122 on which the upstanding elements are implanted are parallel and distinct. The support 22 is made to vibrate.

In FIG. 6, the bases 21 and 22 each have a distinct longitudinal X and X′. The base 21 is a disk. The base 22 is a cube. Its height measured along the axis X is three times the height of the base 21. The two bases are placed on a common plate 212 having an oval cross section. The base 21 is set into a percussive movement along the axis X. It is driven to move over a height equal to four times the height h. When the device is at rest, the surfaces 121 and 122 on which the upstanding elements are implanted are parallel and distinct. The support 22 is made to vibrate.

FIG. 7 shows an assembly comprising a cosmetic receptacle 40 in the form of a tube. It comprises a through-orifice 44 in which at least one base 21 and 22 is removably housed.

In the entire description, the expression “comprising a” should be considered as being synonymous with “comprising at least one”, unless specified to the contrary.

1.-8. (canceled)

9. A cosmetic device, comprising:
an end-piece comprising:
a first base with a first transverse axis comprising at least one first upstanding element; and
a second base with a second transverse axis comprising at least one second upstanding element;
a body configured to receive the end-piece;
a first means for setting the first base in vibratory motion relative to the body along the first transverse axis; and
a second means for setting the second base in motion relative to the body,
wherein the first base and the second base are concentric.

10. The device according to claim 9, wherein the second means for setting the second base in motion is a means for setting the second base in continuous or alternating motion along the first transverse axis.

11. The device according to claim 9, wherein the second means for setting the second base in motion is a means for setting the second base in at least one of a rotational motion, an oscillatory motion, and a percussive motion.

12. The device according to claim 9, wherein the device is configured such that when the device is at rest, surfaces where the at least one first and second upstanding elements are implanted on each of the first and second bases form surfaces of which planes are distinctly or indistinguishably parallel.

13. The device according to claim 9, wherein the device is configured such that when the device is at rest, surfaces where the at least one first and second upstanding elements are implanted on each of the first and second bases form surfaces of which planes are intersecting.

14. A method of massaging a portion of the body, cleansing and/or caring for the skin, and/or application of a cleansing and/or care product to the body and/or skin, said method comprising massaging said portion of the body, cleansing and/or caring for the skin, and/or application of a cleansing and/or care product to the body and/or skin with a cosmetic device comprising:
an end-piece comprising:
a first base with a first transverse axis comprising at least one first upstanding element; and
a second base with a second transverse axis comprising at least one second upstanding element;
a body configured to receive the end-piece;
a first means for setting the first base in vibratory motion relative to the body along the first transverse axis; and
a second means for setting the second base in motion relative to the body,
wherein the first base and the second base are concentric.

15. A kit comprising a cosmetic device, the cosmetic device comprising:
an end-piece comprising:
a first base with a first transverse axis comprising at least one first upstanding element; and
a second base with a second transverse axis comprising at least one second upstanding element;
a body configured to receive the end-piece;
a first means for setting the first base in vibratory motion relative to the body along the first transverse axis; and
a second means for setting the second base in motion relative to the body,
wherein the first base and the second base are concentric.

16. An assembly comprising:
a cosmetic receptacle including a through-hole in which at least one of a first base or a second base included in a device is removably housed, the device comprising:
an end-piece comprising:
the first base with a first transverse axis comprising at least one first upstanding element; and
the second base with a second transverse axis comprising at least one second upstanding element;
a body configured to receive the end-piece;
a first means for setting the first base in vibratory motion relative to the body along the first transverse axis; and
a second means for setting the second base in motion relative to the body,
wherein the first base and the second base are concentric.
